(19) United States
(12) Patent Application Publication
(10) Pub. No.: US 2018/0196602 A1
(43) Pub. Date: Jul. 12, 2018

(54) DATA STORAGE DEVICE AND DATA PROCESSING SYSTEM INCLUDING THE SAME

(71) Applicant: SK hynix Inc., Gyeonggi-do (KR)

(72) Inventor: Deok Cheol SHIN, Gyeonggi-do (KR)

(21) Appl. No.: 15/499,386

(22) Filed: Apr. 27, 2017

(30) Foreign Application Priority Data
Jan. 6, 2017 (KR) 10-2017-0002217

(51) Int. Cl. G06F 3/06

(52) U.S. Cl. CPC G06F 3/0604; G06F 3/0625; G06F 3/0688; G06F 3/0659; G06F 3/0634

(57) ABSTRACT

A data storage device includes a controller suitable for updating a first pointer based on a command inputted to a first queue included in a host device, and updating a second pointer based on a command execution completion report inputted to a second queue included in the host device, wherein the controller determines whether it is in an idle state based on the first pointer and the second pointer.

### CROSS-REFERENCES TO RELATED APPLICATION

The present application claims priority under 35 U.S.C. § 119(a) to Korean application number 10-2017-0002217, filed on Jan. 6, 2017, in the Korean Intellectual Property Office, which is incorporated herein by reference in its entirety.

### BACKGROUND

### 1. Technical Field

Various embodiments generally relate to a data storage device and a data processing system including the same.

### 2. Related Art

Data storage devices store data received from an external device in response to a write request. Data storage devices may also provide stored data to an external device in response to a read request. Examples of external devices that use data storage devices include computers, digital cameras, cellular phones and the like. Data storage devices may be embedded in an external device during manufacturing of the external devices or may be fabricated separately and then connected afterwards to an external device.

### SUMMARY

Various embodiments are directed to provide a data storage device capable for determining when to be in an idle state.

In an embodiment, a data storage device may include: a controller suitable for updating a first pointer based on a command inputted to a first queue included in a host device, and updating a second pointer based on a command execution completion report inputted to a second queue included in the host device, wherein the controller determines whether it is in an idle state based on the first pointer and the second pointer.

In an embodiment, a data processing system may include: a host device suitable for inputting a command to a first queue, and receiving a command execution completion report through a second queue; and a data storage device suitable for updating a first pointer based on the command inputted to the first queue, and updating a second pointer based on the command execution completion report inputted to the second queue, wherein the data storage device determines whether it is in an idle state based on the first pointer and the second pointer.

In an embodiment, a data storage device may include: a controller suitable for updating a first pointer in response to a first doorbell write operation of a host device, fetching a command from the host device and executing the command, and updating a second pointer in response to a second doorbell write operation of the host device in response to a command execution completion report, wherein the controller determines whether it is in an idle state based on the first pointer and the second pointer.

In an embodiment, a method of operating a data storage device may include: updating a first pointer in response to a first doorbell write operation of a host device; fetching a command from the host device and executing the command; inputting a command execution completion report to the host device; updating a second pointer in response to a second doorbell write operation of the host device, which is performed in response to the command execution completion report; and determining whether it is in an idle state based on the first pointer and the second pointer.

### BRIEF DESCRIPTION OF THE DRAWINGS

The above and other features and advantages of the present invention will become more apparent to those skilled in the art to which the present invention belongs by describing various embodiments thereof with reference to the attached drawings in which:

FIG. 1 is a block diagram illustrating a data processing system, in accordance with an embodiment of the present invention.

FIG. 2 is a diagram illustrating an exemplary command processing procedure, in accordance with an embodiment of the present invention.

FIG. 3 is a diagram illustrating a plurality of pairs of submission queues and completion queues included in a host device of a data processing system, in accordance with an embodiment of the present invention.

FIG. 4 is a flow chart of a method for operating a data storage device, in accordance with an embodiment of the present invention.

FIG. 5 is a block diagram illustrating a data storage device, in accordance with another embodiment of the present invention.

FIG. 6 is a block diagram illustrating a data processing system in accordance with yet another embodiment of the present invention.

### DETAILED DESCRIPTION

Hereinafter, a data storage device and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated in order to more clearly depict certain features of the invention. While particular terminology is used, it is to be appreciated that the terminology used is for describing particular embodiments only and is not intended to limit the scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

The term “or” as used herein means either one of two or more alternatives but not both nor any combinations thereof.

As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element also referred to as a feature described in connection with one embodiment may be used singly or in combination with other elements of another embodiment, unless specifically indicated otherwise.

Hereinafter, the various embodiments of the present invention will be described in detail with reference to the attached drawings.

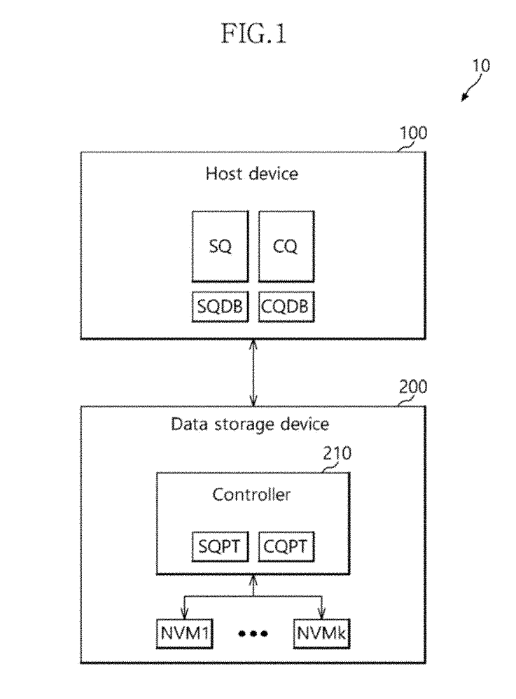

FIG. 1 is a block diagram illustrating a data processing system 10 in accordance with an embodiment of the present invention.

While the data processing system 10 may include, for example, a workstation, a desktop computer, a laptop computer, a mobile computer, a smart phone, a tablet PC, a video camera, a navigator or a game console, it is to be noted that the embodiment is not limited thereto.

The data processing system 10 may include a host device 100 and a data storage device 200 which stores data according to control of the host device 100. While the host device 100 and the data storage device 200 may interface with each other, based on, for example, a nonvolatile memory (NVM) express, it is to be noted that an interfacing method is not limited thereto.

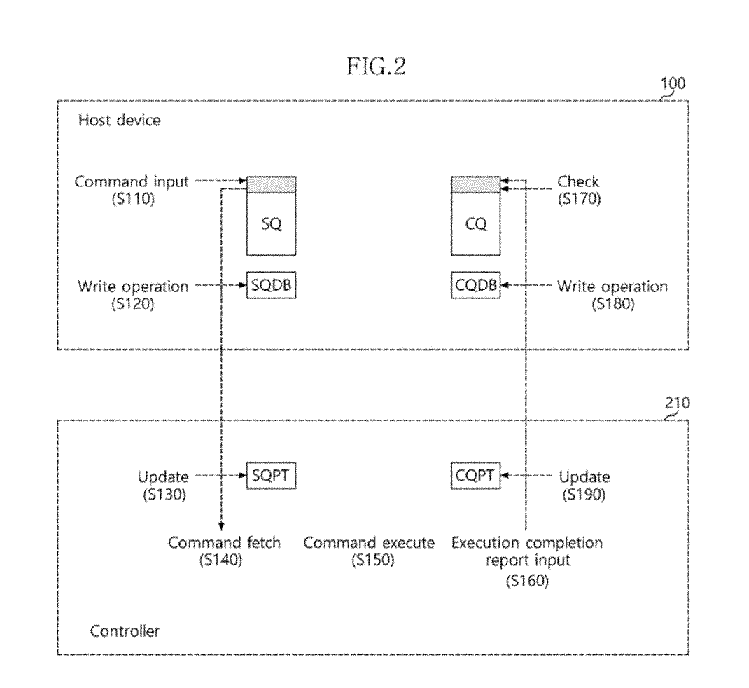

In order to control the data storage device 200, the host device 100 may generate a command and provide the generated command to the data storage device 200. The host device 100 may process the command to provide to the data storage device 200, by using a submission queue SQ, a completion queue CQ, a submission queue doorbell region SQDB and a completion queue doorbell region CQDB. In detail, the host device 100 may input the command to the submission queue SQ, and perform a write operation on the submission queue doorbell region SQDB, that is, a submission queue doorbell write operation. After the data storage device 200 fetches and executes the command in response to the submission queue doorbell write operation, the host device 100 may receive a command execution completion report through the completion queue CQ from the data storage device 200, and perform a write operation on the completion queue doorbell region CQDB, that is, a completion queue doorbell write operation. A detailed command processing method of the host device 100 will be described later with reference to FIG. 2.

While the data storage device 200 may include, for example, a Personal Computer Memory Card International Association (PCMCIA) card, a Compact Flash (CF) card, a smart media card, a memory stick, various multimedia cards (e.g., MMC, eMMC, RS-MMC, and MMC-Micro), various secure digital cards (e.g., SD, Mini-SD, and Micro-SD), a Universal Flash Storage (UFS) or a Solid State Drive (SSD), it is to be noted that the embodiment is not limited thereto.

The data storage device 200 may include a controller 210 and a plurality of nonvolatile memory devices NVM1 to NVMk which store data according to control of the controller 210.

The controller 210 may fetch the command from the submission queue SQ of the host device 100, execute the fetched command, and input the command execution completion report to the completion queue CQ. The controller 210 may update a submission queue pointer SQPT based on the command inputted to the submission queue SQ, and update a completion queue pointer CQPT based on the command execution completion report inputted to the completion queue CQ, thereby managing a command execution state.

In detail, the controller 210 may update the submission queue pointer SQPT when the host device 100 performs the write operation on the submission queue doorbell region SQDB after inputting the command to the submission queue SQ. Further, the controller 210 may update the completion queue pointer CQPT when the host device 100 performs the write operation on the completion queue doorbell region CQDB in response to the command execution completion report inputted to the completion queue CQ.

Summarizing these, command processing of the data storage device 200 may start in response to an update of the submission queue pointer SQPT, and end in response to an update of the completion queue pointer CQPT. The controller 210 may determine whether or not it is in an idle state, based on the submission queue pointer SQPT and the completion queue pointer CQPT. An idle state may be a state in which an unexecuted/pending command does not exist in the data storage device 200. According to an embodiment, the controller 210 may enter a low power mode or perform various background operations when it is determined to be in an idle state. According to an embodiment, the controller 210 may determine whether it is in an idle state, when updating the completion queue CQ or by a predetermined condition.

As a consequence, according to the present embodiment, whether it is in an idle state may be determined efficiently and clearly based on the submission queue pointer SQPT and the completion queue pointer CQPT. An exemplary method for determining whether the controller 210 is in an idle state will be described below in detail through subsequent drawings.

The plurality of nonvolatile memory devices NVM1 to NVMk may store data transmitted from the controller 210 and may read stored data and transmit the read data to the controller 210, according to control of the controller 210.

While a nonvolatile memory device may include a flash memory, such as a NAND flash or a NOR flash, a Ferroelectrics Random Access Memory (FeRAM), a Phase-Change Random Access Memory (PCRAM), a Magnetoresistive Random Access Memory (MRAM) or a Resistive Random Access Memory (ReRAM), it is to be noted that the embodiment is not limited thereto.

FIG. 2 is a diagram illustrating an exemplary detailed command processing procedure in accordance with an embodiment of the present invention. FIG. 2 illustrates the submission queue SQ, the completion queue CQ, the submission queue doorbell region SQDB and the completion queue doorbell region CQDB of the host device 100. FIG. 2 also illustrates the submission queue pointer SQPT and the completion queue pointer CQPT of the controller 210. In FIG. 2, steps S110 to S190 may be performed sequentially.

In detail, at the step S110, the host device 100 may input a command to the submission queue SQ. The submission queue SQ may be, for example, but not limited to, a circular queue.

At the step S120, the host device 100 may perform a write operation on the submission queue doorbell region SQDB, based on the command inputted to the submission queue SQ. For example, information to be written in the submission queue doorbell region SQDB may include a submission queue position information on a position where the command is inputted to the submission queue SQ. In other words, the write operation on the submission queue doorbell region SQDB may be performed to notify the controller 210 that the command to be fetched exists at a specified position of the submission queue SQ.

At the step S130, the controller 210 may update the submission queue pointer SQPT in response to the write operation of the host device 100 on the submission queue doorbell region SQDB. More specifically, the submission queue pointer SQPT may be updated to have a value corresponding to the specific position where the command is inputted in the submission queue SQ. For example, the submission queue pointer SQPT may be updated by being increased by 1. The controller 210 may update the submission queue pointer SQPT by accessing the submission queue doorbell region SQDB and identifying the submission queue position information written in the submission queue doorbell region SQDB. According to an embodiment, the controller 210 may update the submission queue pointer SQPT in response to a signal which is transmitted from the host device 100 based on the submission queue doorbell region SQDB.

At the step S140, the controller 210 may fetch the command from the submission queue SQ.

At the step S150, the controller 210 may execute the fetched command.

At the step S160, the controller 210 may input a command execution completion report to the completion queue CQ. A position where the command execution completion report is inputted to the completion queue CQ may correspond to the specific position where the command is inputted to the submission queue SQ. The completion queue CQ may be, for example, but not limited to, a circular queue.

At the step S170, the host device 100 may check the command execution completion report inputted to the completion queue CQ.

At the step S180, the host device 100 may perform a write operation on the completion queue doorbell region CQDB, in response to the command execution completion report inputted to the completion queue CQ. For example, information to be written in the completion queue doorbell region CQDB may include a completion queue position information on a position where the command execution completion report is inputted to the completion queue CQ. Namely, the write operation on the completion queue doorbell region CQDB may be performed to notify the controller 210 that the host device 100 has checked command execution completion.

At the step S190, the controller 210 may update the completion queue pointer CQPT in response to the write operation of the host device 100 on the completion queue doorbell region CQDB. The completion queue pointer CQPT may be updated to have a value corresponding to the position where the command execution completion report is inputted to the completion queue CQ. For example, the completion queue pointer CQPT may be updated by being increased by 1. The controller 210 may update the completion queue pointer CQPT by accessing the completion queue doorbell region CQDB and identifying the completion queue position information written in the completion queue doorbell region CQDB. According to an embodiment, the controller 210 may update the completion queue pointer CQPT in response to a signal which is transmitted from the host device 100 based on the completion queue doorbell region CQDB.

According to the command processing procedure explained heretofore through the steps S110 to S190, command processing of the data storage device 200 may start in response to an update of the submission queue pointer SQPT, and end in response to an update of the completion queue pointer CQPT. Therefore, in order to determine whether it is in an idle state, the controller 210 may refer to the submission queue pointer SQPT and the completion queue pointer CQPT. That is, because the submission queue SQ and the completion queue CQ correspond to each other, the submission queue pointer SQPT may match the completion queue pointer CQPT when an unexecuted/pending command does not exist in the data storage device 200. In other words, the controller 210 may determine that it is in an idle state, when the submission queue pointer SQPT and the completion queue pointer CQPT are the same.

FIG. 1 illustrates a certain pair of submission queue SQ and completion queue CQ included in the host device 100. However, as will be described below, according to an embodiment, the host device 100 may include a plurality of pairs of submission queues SQ and completion queues CQ.

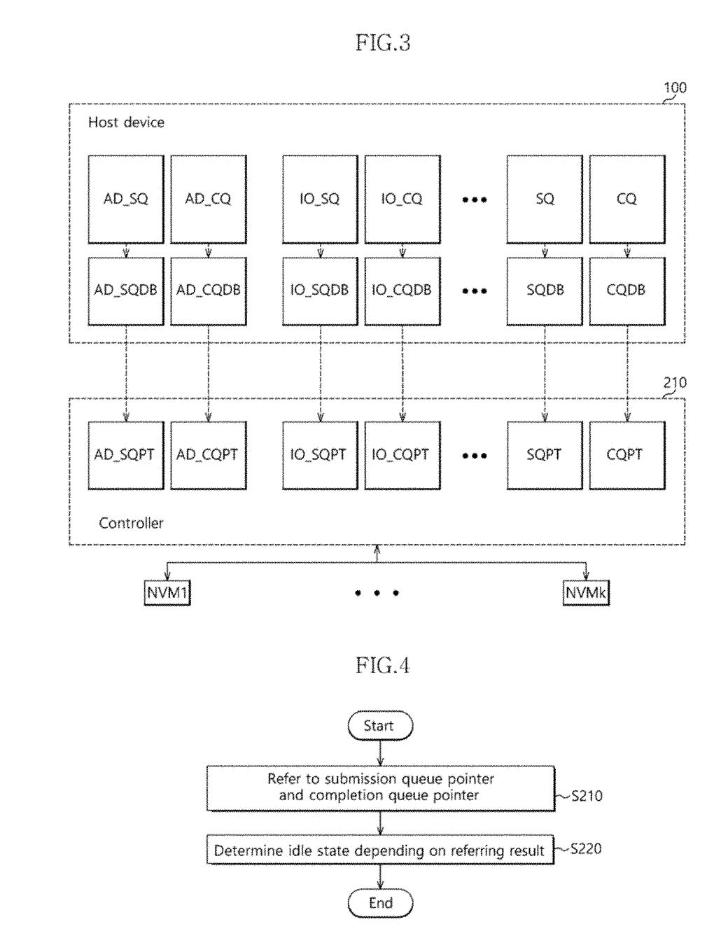

FIG. 3 is a block diagram illustrating a data processing system in accordance with an embodiment of the present invention. In FIGS. 1 and 3, like reference numerals are used to refer to the same element.

Referring to FIG. 3, the data processing system may include a host device 100 in which a plurality of pairs of submission queues SQ and completion queues CQ are included. The plurality of respective pairs of submission queues SQ and completion queues CQ may be provided for various purposes. For example, the plurality of pairs of submission queues SQ and completion queues CQ may be provided to correspond to a plurality of core processors, respectively, included in the host device 100.

At least one pair of submission queue SQ and completion queue CQ among the plurality of pairs of submission queues SQ and completion queues CQ, for example, a pair of management submission queue AD_SQ and management completion queue AD_CQ may be provided to process management commands for management operations of the controller 210. The management operations of the controller 210 may be operations associated with, for example, format, reset, queue generation, and so forth. At least one pair of submission queue SQ and completion queue CQ among the plurality of pairs of submission queues SQ and completion queues CQ, for example, a pair of input/output submission queue IO_SQ and input/output completion queue IO_CQ may be provided to process input/output commands for write operations and read operations of a plurality of nonvolatile memory devices (NVM1 to NVMk of FIG. 1).

In these cases, submission queue doorbell regions SQDB and completion queue doorbell regions CQDB of the host device 100 and submission queue pointers SQPT and completion queue pointers CQPT of the controller 210 may be respectively provided in correspondence to the submission queues SQ and the completion queues CQ provided in the host device 100. In FIG. 3, the arrows extending from the plurality of pairs of submission queues SQ and completion queues CQ represent such correspondence relationship. The host device 100 and the controller 210 may process a command for each pair of submission queue SQ and completion queue CQ, in the same method as described above with reference to FIG. 2.

For example, for the management submission queue AD_SQ and the management completion queue AD_CQ, the host device 100 may include a management submission queue doorbell region AD_SQDB and a management completion queue doorbell region AD_CQDB, and the controller 210 may include a management submission queue pointer AD_SQPT and a management completion queue pointer AD_CQPT. The host device 100 may perform a write operation on the management submission queue doorbell region AD_SQDB, based on a management command inputted to the management submission queue AD_SQ, and the controller 210 may update the management submission queue pointer AD_SQPT. Also, the host device 100 may perform a write operation on the management completion queue doorbell region AD_CQDB, based on a management command execution completion report inputted to the management completion queue AD_CQ, and the controller 210 may update the management completion queue pointer AD_CQPT.

According to an embodiment, the controller 210 may determine whether it is in an idle state for each type of commands, that is, for the management command and the input/output command. Moreover, according to an embodiment, the controller 210 may determine whether it is in an idle state, for each of a plurality of pairs of submission queues SQ and completion queues CQ.

Meanwhile, according to an embodiment, the host device 100 may provide an asynchronous event request command to the controller 210. The asynchronous event request command, as one for controlling a management operation of the controller 210 associated with, for example, error and health, may be a command of which execution completion report to the host device 100 is not required. An allowable number of asynchronous event request commands may be determined by control of the host device 100. Therefore, when determining whether it is in an idle state for the management command, based on the management submission queue pointer AD_SQPT and the management completion queue pointer AD_CQPT, the controller 210 may refer to the number of currently fetched asynchronous event request commands. For example, the controller 210 may determine that it is in an idle state, when the management submission queue pointer AD_SQPT matches the sum of the management completion queue pointer AD_CQPT and the number of asynchronous event request commands.

FIG. 4 is a flow chart of a method for operating the data storage device 200 in accordance with an embodiment of the present invention. FIG. 4 illustrates a method for the controller 210 to determine whether it is in an idle state, for any one pair of submission queues SQ and completion queues CQ.

Referring to FIG. 4, at step S210, the controller 210 may refer to the submission queue pointer SQPT and the completion queue pointer CQPT.

At step S220, the controller 210 may determine whether it is in an idle state, depending on the result of the referring step. For example, the controller 210 may determine that it is in an idle state, when the submission queue pointer SQPT matches the completion queue pointer CQPT. For example, when asynchronous event request commands are supported, the controller 210 may determine that it is in an idle state, when the submission queue pointer SQPT matches the sum of the completion queue pointer CQPT and the number of asynchronous event request commands.

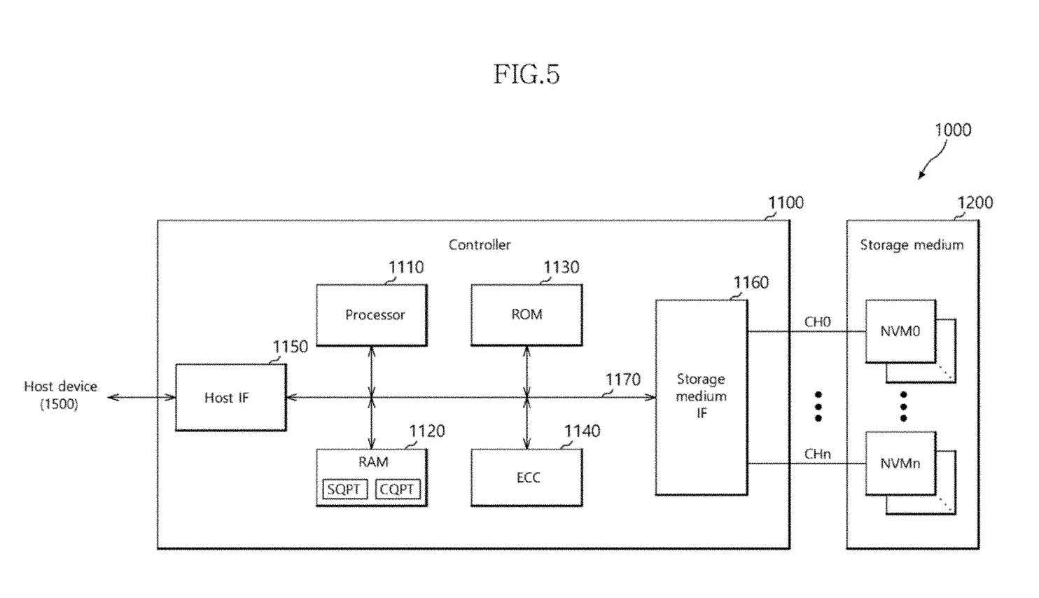

FIG. 5 is a block diagram illustrating a data storage device 1000 in accordance with an embodiment of the present invention.

The data storage device 1000 may include a controller 1100 and a storage medium 1200.

The controller 1100 may control data exchange between a host device 1500 and the storage medium 1200. The controller 1100 may include a processor 1110, a random access memory (RAM) 1120, a read only memory (ROM) 1130, an error correction code (ECC) unit 1140, a host interface 1150 and a storage medium interface 1160 which are coupled through an internal bus 1170.

The controller 1100 may operate substantially similarly to the controller 210 shown in FIG. 1. The controller 1100 may update a submission queue pointer SQPT based on a command inputted to a submission queue included in the host device 1500, and update a completion queue pointer CQPT based on a command execution completion report inputted to a completion queue included in the host device 1500. Also, the controller 1100 may determine whether it is in an idle state, by referring to the submission queue pointer SQPT and the completion queue pointer CQPT.

The processor 1110 may control general operations of the controller 1100. The processor 1110 may store data in the storage medium 1200 and read stored data from the storage medium 1200, according to data processing requests from the host device 1500. In order to efficiently manage the storage medium 1200, the processor 1110 may also control internal operations of the SSD 1000 such as a merge operation, a wear leveling operation, and so forth.

The RAM 1120 may store programs and program data to be used by the processor 1110. The RAM 1120 may temporarily store data transmitted from the host interface 1150 before transferring it to the storage medium 1200, and may temporarily store data transmitted from the storage medium 1200 before transferring it to the host device 1500. While the RAM 1120 may store the submission queue pointer SQPT and the completion queue pointer CQPT, a position where the submission queue pointer SQPT and the completion queue pointer CQPT are stored is not limited thereto.

The ROM 1130 may store program codes to be read by the processor 1110. The program codes may include commands to be processed by the processor 1110, for the processor 1110 to control the internal units of the controller 1100.

The ECC unit 1140 may encode data to be stored in the storage medium 1200, and may decode data read from the storage medium 1200. The ECC unit 1140 may detect and correct an error occurred in data, according to an ECC algorithm.

The host interface 1150 may exchange data processing requests, data, etc. with the host device 1500. The host interface 1150 may interface with the host device 1500 based on, for example, an NVM express.

The storage medium interface 1160 may transmit control signals and data to the storage medium 1200. The storage medium interface 1160 may receive data from the storage medium 1200. The storage medium interface 1160 may be coupled with the storage medium 1200 through a plurality of channels CH0 to CHn.

The storage medium 1200 may include a plurality of nonvolatile memory devices NVM0 to NVMn. Each of the plurality of nonvolatile memory devices NVM0 to NVMn may perform a write operation and a read operation according to control of the controller 1100.

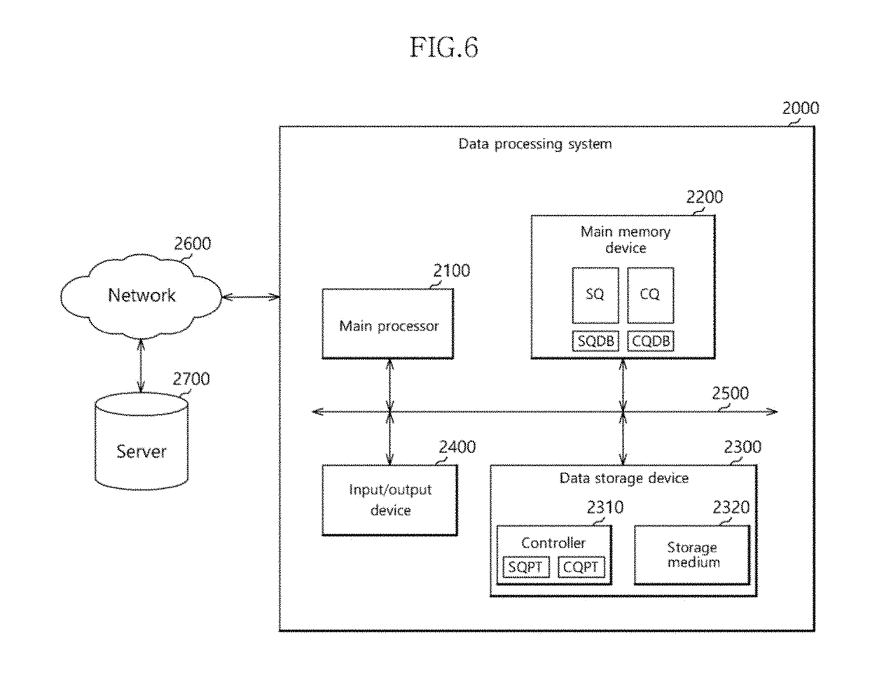

FIG. 6 is a block diagram illustrating a data processing system 2000 in accordance with an embodiment of the present invention.

The data processing system 2000 may include a main processor 2100, a main memory device 2200, a data storage device 2300, and an input/output device 2400. The internal units of the data processing system 2000 may exchange data, control signals, etc. through a system bus 2500.

The main processor 2100 may control general operations of the data processing system 2000. The main processor 2100 may be a central processing unit, for example, such as a microprocessor. The main processor 2100 may execute softwares such as an operating system, an application, a device driver, and so forth, on the main memory device 2200. The main processor 2100 may process a command for the data storage device 2300 by using a submission queue SQ, a completion queue CQ, a submission queue doorbell region SQDB and a completion queue doorbell region CQDB, in substantially the same manner as the command processing method of the host device 100 shown in FIG. 1.

The main memory device 2200 may store programs and program data to be used by the main processor 2100. The main memory device 2200 may temporarily store data to be transmitted to the data storage device 2300 and the input/output device 2400. In addition, the main memory device 2200 may store the submission queue SQ, the completion queue CQ, the submission queue doorbell region SQDB and the completion queue doorbell region CQDB.

The data storage device 2300 may include a controller 2310 and a storage medium 2320. The controller 2310 may be configured and operate in substantially the same manner as the controller 210 of FIG. 1. The controller 2310 may manage a submission queue pointer SQPT and a completion queue pointer CQPT, and determine whether to be in an idle state, based on the submission queue pointer SQPT and the completion queue pointer CQPT.

The input/output device 2400 may include a keyboard, a scanner, a touch screen, a screen monitor, a printer, a mouse, or the like, capable of exchanging data with a user, such as receiving a command for controlling the data processing system 2000 from the user or providing a processed result to the user.

According to an embodiment, the data processing system 2000 may communicate with at least one server 2700 through a network 2600 such as a local area network (LAN), a wide area network (WAN), a wireless network, and so on. The data processing system 2000 may include a network interface (not shown) to access the network 2600.

While various embodiments have been described above, it will be understood to those skilled in the art that the embodiments described are examples only. Accordingly, the data storage device and the operating method thereof described herein should not be limited to the described embodiments. It will be apparent to those skilled in the art to which the present invention pertains that various other changes and modifications may be made without departing from the spirit and scope of the invention as defined in the following claims.

What is claimed is:

1. A data storage device comprising:
a controller suitable for updating a first pointer based on a command inputted to a first queue included in a host device, and updating a second pointer based on a command execution completion report inputted to a second queue included in the host device,
wherein the controller determines whether it is in an idle state based on the first pointer and the second pointer.

2. The data storage device according to claim 1, wherein the controller determines that it is in an idle state when the first pointer matches the second pointer.

3. The data storage device according to claim 1, wherein the controller determines that it is in an idle state when the first pointer matches a sum of the second pointer and a number of asynchronous event request commands.

4. The data storage device according to claim 1, wherein the controller updates the first pointer when the host device performs a first doorbell write operation after inputting the command to the first queue.

5. The data storage device according to claim 1, wherein, after updating the first pointer, the controller fetches the command from the first queue and executes the fetched command.

6. The data storage device according to claim 1, wherein the controller inputs the command execution completion report to the second queue and updates the second pointer when the host device performs a second doorbell write operation in response to the command execution completion report.

7. The data storage device according to claim 1, wherein the controller interfaces with the host device based on a nonvolatile memory (NVM) express.

8. A data processing system comprising:
a host device suitable for inputting a command to a first queue, and receiving a command execution completion report through a second queue; and
a data storage device suitable for updating a first pointer based on the command inputted to the first queue, and updating a second pointer based on the command execution completion report inputted to the second queue,
wherein the data storage device determines whether it is in an idle state based on the first pointer and the second pointer.

9. The data processing system according to claim 8, wherein the data storage device determines that it is in an idle state when the first pointer matches the second pointer.

10. The data processing system according to claim 8, wherein the data storage device determines that it is in an idle state when the first pointer matches a sum of the second pointer and a number of asynchronous event request commands.

11. The data processing system according to claim 8, wherein the data storage device updates the first pointer when the host device performs a first doorbell write operation after inputting the command to the first queue.

12. The data processing system according to claim 8, wherein, after updating the first pointer, the data storage device fetches the command from the first queue and executes the fetched command.

13. The data processing system according to claim 8, wherein the data storage device inputs the command execution completion report to the second queue and updates the second pointer when the host device performs a second doorbell write operation in response to the command execution completion report.

14. The data processing system according to claim 8, wherein the host device and the data storage device interface with each other based on a nonvolatile memory (NVM) express.

15. A data storage device comprising:
a controller suitable for updating a first pointer in response to a first doorbell write operation of a host device, fetching a command from the host device and executing the command, and updating a second pointer in response to a second doorbell write operation of the host device in response to a command execution completion report,
wherein the controller determines whether it is in an idle state based on the first pointer and the second pointer.

16. The data storage device according to claim 15, wherein the controller determines that it is in an idle state when the first pointer matches the second pointer.

17. The data storage device according to claim 15, wherein the controller determines that it is in an idle state when the first pointer matches a sum of the second pointer and a number of asynchronous event request commands.

18. The data storage device according to claim 15, wherein the controller interfaces with the host device based on a nonvolatile memory (NVM) express.
